(19) United States
(12) Patent Application Publication
(10) Pub. No.: US 2013/0335908 A1
(43) Pub. Date: Dec. 19, 2013

(54) CONTAINER DATA CENTER AND ELECTROMAGNETIC INTERFERENCE INHIBITING DEVICE FOR CABLE OF THE SAME

(71) Applicant: WEN-KAI CHIANG, Tu-Cheng (TW)

(72) Inventor: WEN-KAI CHIANG, Tu-Cheng (TW)

(73) Assignee: HON HAI PRECISION INDUSTRY CO., LTD., Tu-Cheng (TW)

(21) Appl. No.: 13/551,631

(22) Filed: Jul. 18, 2012

(30) Foreign Application Priority Data
Jun. 15, 2012 (TW) 101121660

(51) Int. Cl. H01R 13/648; G06F 1/16

(52) U.S. Cl. 361/679.31; 174/360

(57) ABSTRACT

An electromagnetic interference (EMI) inhibiting device which prevents EMI from being transferred through a server cable from the outside to the inside or vice versa. Metal oxide powders packed between the cylinder and the cable act as an absorbant and dissipator of any EMI.

### BACKGROUND

1. Technical Field

The present disclosure relates to container data centers, and particularly to a container data center having an electromagnetic interference (EMI) inhibiting device.

2. Description of Related Art

Electronic devices, such as container data centers, shielding rooms, or anechoic chambers, have cables extending through the housings of the electronic devices to the external environment. Electromagnetic radiation from the electronic devices may leak through the cables. At the same time, electromagnetic radiation from the outside environment may enter the electronic devices through the cables to interfere with the electronic devices. Thus, there is room to improve the art.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the various views.

FIG. 1 is a sectional view of a cable leading into a container data center with an EMI-inhibiting device in accordance with a first embodiment of the disclosure.

FIGS. 2-3 are schematic views of the EMI-inhibiting device of FIG. 1 in use.

FIG. 4 is a sectional view of a container data center with an EMI-inhibiting device in accordance with a second embodiment of the disclosure.

FIGS. 5-8 are sectional views of the EMI-inhibiting device of FIG. 4 in use.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

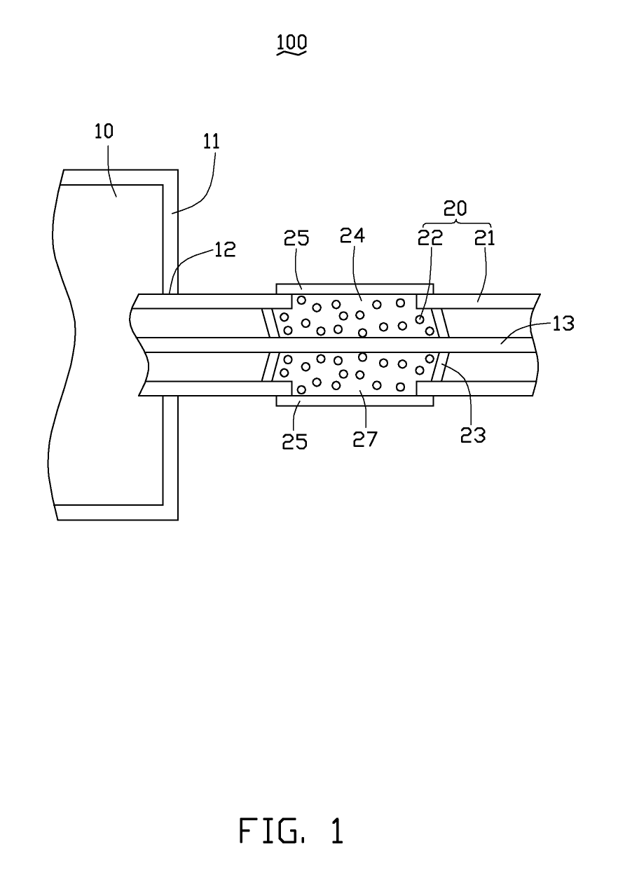

Referring to FIG. 1, a container data center 100 in accordance with a first embodiment of the disclosure includes a container 10 for accommodating a plurality of servers (not shown) and an electromagnetic interference (EMI) inhibiting device 20 mounted to the container 10.

The container 10 includes a sidewall 11 defining a wire hole 12, and a cable 13 extending through the wire hole 12. The EMI-inhibiting device 20 is applied towards inhibiting any EMI between the container 10 and the outside environment by means of the cable 13. The EMI-inhibiting device 20 includes a metal cylinder 21 fitting about the cable 13 and an amount(s) of metal oxide powders 22 packed in a gap between the metal cylinder 21 and the cable 13 which is sufficient to inhibit EMI. The metal cylinder 21 has an end inserted into the wire hole 12 and the circumferential edge bounds the wire hole 12. The metal cylinder 21 has an elongated configuration.

The metal cylinder 21 includes two blocking tabs 23 spaced in a lengthways direction of the metal cylinder 21, to keep the metal oxide powders 22 between the blocking tabs 23. Each of the blocking tabs 23 has a circumferential edge firmly abutting an inner surface of the metal cylinder 21. Each blocking tab 23 defines a central through hole (not labeled). The cable 13 extends through the through holes of the blocking tabs 23. Each blocking tab 23 is a sheet made of elastic material, such as rubber or plastic.

The metal cylinder 21 defines an inlet 24 communicating with the space between the blocking tabs 23 and the metal cylinder 21 in a top side and an outlet 27 communicating with the space between the blocking tabs 23 and the metal cylinder 21 in a bottom side. The inlet 24 of the metal cylinder 21 is used for loading the metal oxide powders 22 into the space between the blocking tabs 23 and the metal cylinder 21, and the outlet 27 is used for unloading the metal oxide powders 22 from the space. The metal cylinder 21 includes two metal covers 25 for the inlet 24 and the outlet 27. The inlet 24 and the outlet 27 are defined between the blocking tabs 23. The metal covers 25 each have an end rotatably connected to the metal cylinder 21.

The metal oxide powders 22 are magnetic and conductive, such as Mn—Zn ferrite powder or Ni—Zn ferrite powder.

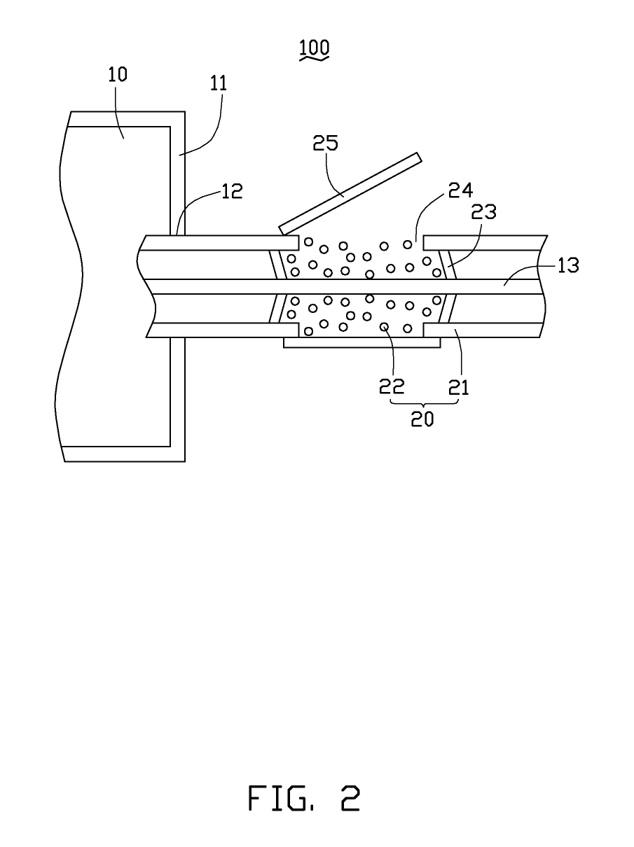

Referring to FIG. 2, in use, the metal cover 25 at the inlet 24 of the metal cylinder 21 is opened, and the metal oxide powders 22 are loaded in the space between the blocking tabs 23 and the metal cylinder 21, until the quantity of metal oxide powers 22 in the space is sufficient to inhibit EMI. The metal cover 25 covers the inlet 24.

The EMI-inhibiting device 20 absorbs and dissipates any electromagnetic radiation transferred along the cable 13 between the internal and the external parts of the container 10.

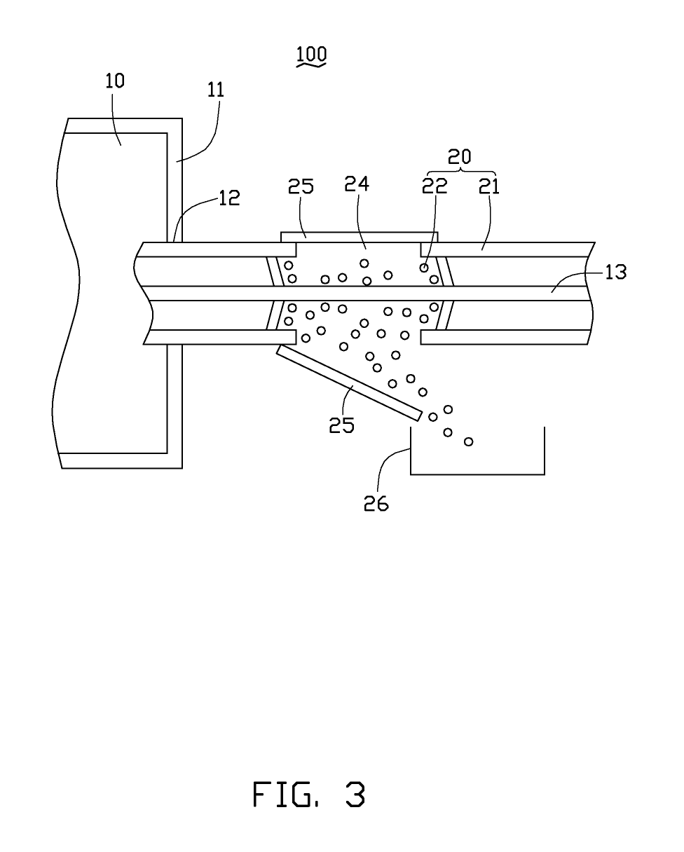

Referring to FIG. 3, when the cable 13 needs to be replaced or removed, the metal cover 25 at the outlet 27 of the metal cylinder 21 is opened. The metal oxide powders 22 are unloaded from the space through the outlet 27 and drop into a powder container 26. Therefore, the metal oxide powders 22 are reusable.

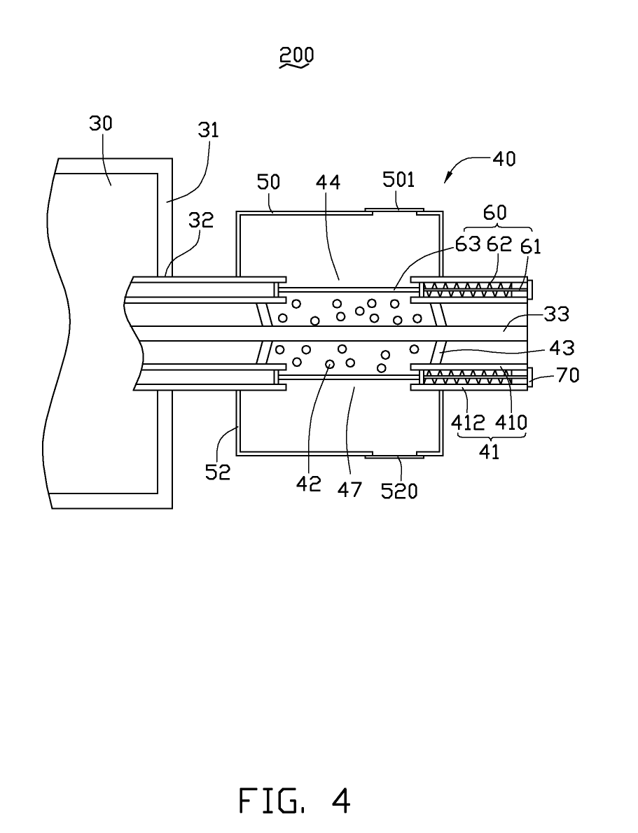

Referring to FIG. 4, a container data center 200 in accordance with a second embodiment of the disclosure is illustrated. The container data center 200 includes a container 30 and a EMI-inhibiting device 40 mounted to the container 30.

The container 30 includes a sidewall 31 defining a wire hole 32, and a cable 33 extending through the wire hole 32. The EMI-inhibiting device 40 inhibits EMI between the container 30 and the external environment through the cable 33. The EMI-inhibiting device 40 includes a metal cylinder 41 fitting around the cable 33, a first box 50 and a second box 52 mounted on an external portion of the metal cylinder 41, a first switching assembly 60 and a second switching assembly 70 mounted in the metal cylinder 41, and metal oxide powders 42 packed into a gap between the metal cylinder 41 and the cable 33, sufficient to inhibit EMI.

The metal cylinder 41 includes an inner tube 410 and an outer tube 412 wrapping the inner tube 410. The inner tube 410 is spaced from the outer tube 412. The outer tube 412 has an end inserted into the wire hole 32 of the container 30 and engaged with a circumferential edge bounding the wire hole 32. The inner tube 410 and the outer tube 412 each have an elongated configuration. The metal oxide powders 42 are packed in a gap between the inner tube 410 and the cable 33.

The metal cylinder 41 includes two blocking tabs 43 spaced in a lengthways direction of the metal cylinder 41, to keep the metal oxide powders 42 between the blocking tabs 43. Each of the blocking tabs 43 has a circumferential edge firmly abutting an inner surface of the inner tube 410 of the metal cylinder 41. Each blocking tab 43 defines a central through hole (not labeled). The cable 33 extends through the through holes of the blocking tabs 43. The metal oxide powders 42 are located between the blocking tabs 43. Each blocking tab 43 is a sheet made of elastic material, such as rubber or plastic.

The metal cylinder 41 defines an inlet 44 communicating with a space between the blocking tabs 43 and the metal cylinder 41 in a top side and an outlet 47 communicating with the space between the blocking tabs 43 and the metal cylinder 41 in a bottom side. The inlet 44 and the outlet 47 are located between the blocking tabs 43.

The first box 50 is mounted on the top of the metal cylinder 41 and covers the inlet 44. The inlet 44 communicates with an inner space of the first box 50. The first box 50 defines a first hinged door 501 at a top of the first box 50. The second box 52 is mounted on the bottom of the metal cylinder 41 and covers the outlet 47. The outlet 47 communicates with an inner space of the second box 52. The second box 52 defines a second hinged door 520 at a bottom side. The first and second boxes 50 and 52 each are made of metal.

The first switching assembly 60 and the second switching assembly 70 are located between the inner tube 410 and the outer tube 412 of the metal cylinder 41. The first switching assembly 60 is on the top of the metal cylinder 41. The second switching assembly 70 is at the bottom of the metal cylinder 41.

The first switching assembly 60 includes a handle 61, an elastic member 62, and a metal plate 63. The handle 61 includes a first end extending out of an outer end of the metal cylinder 41 opposite to the sidewall 31, and an opposite second end inserted into the metal cylinder 41 between the inner and outer tubes 410 and 412 and connected to an end of the metal plate 63. The metal plate 63 covers the inlet 44. An opposite end of the metal plate 62 is inserted into the metal cylinder 41 adjacent to the sidewall 31. The elastic member 62 includes a first end secured to the outer end of the metal cylinder 41 and an opposite second end connected with a connection portion between the handle 61 and the metal plate 63. The elastic member 62 is compressed between the outer end of the metal cylinder 41 and the connection portion of the handle 61 and the metal plate 63. In this embodiment, the elastic member 62 is a spring. The second switching assembly 70 is similar to the first switching assembly 60.

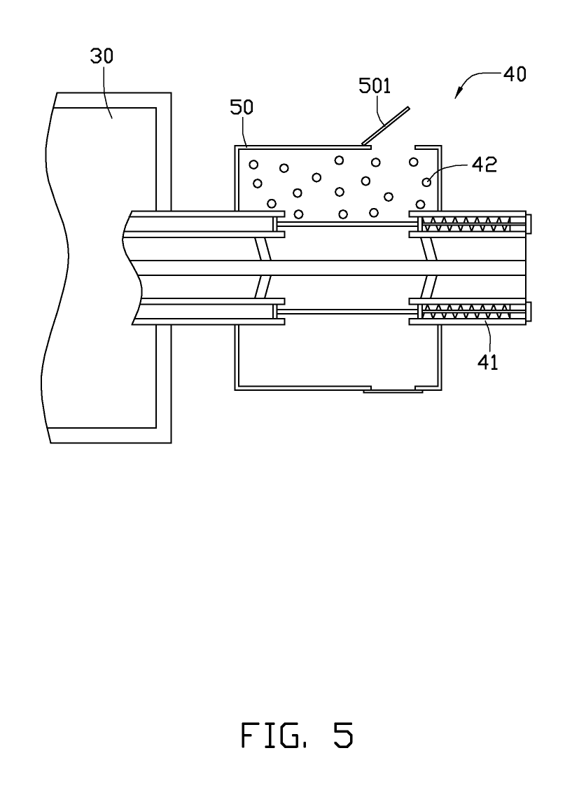

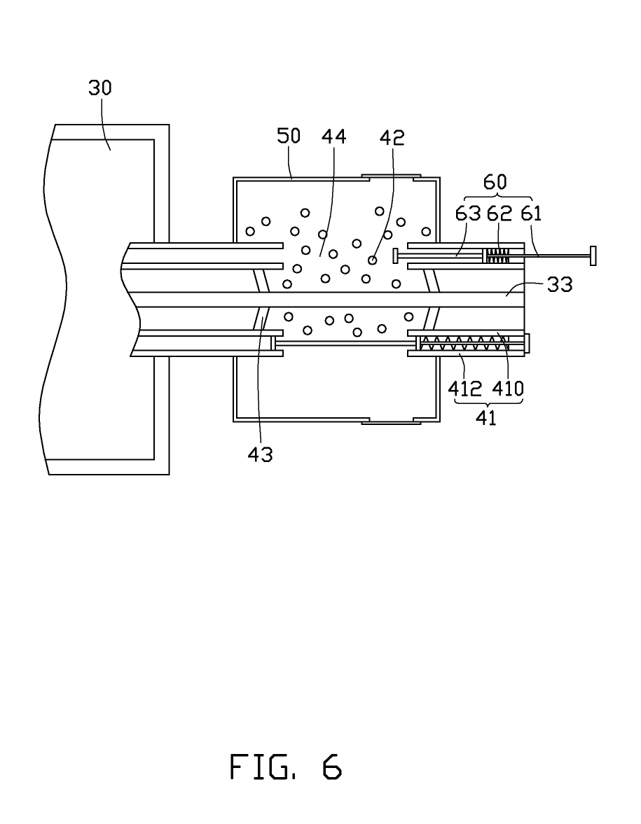

Referring to FIG. 5, in use, the inlet 44 and the outlet 47 are closed by the first and second switching assemblies 60 and 70, and the metal oxide powders 42 are stored in the first box 50. Referring to FIG. 6, the handle 61 of the first switching assembly 60 is pulled out, and the metal plate 63 is pulled away from the inlet 44 against the elastic member 62, to uncover the inlet 44. The metal oxide powders 42 in the first box 50 are loaded in the inner tube 410 through the inlet 44. When the metal oxide powders 42 fill the gap among the inner tube 410, the blocking tabs 43, and the cable 33, the metal plate 63 recovers the inlet 44 under the elastic force of the elastic member 62. The EMI-inhibiting device 40 absorbs and dissipates any electromagnetic radiation originating internally and externally in relation to the container 30.

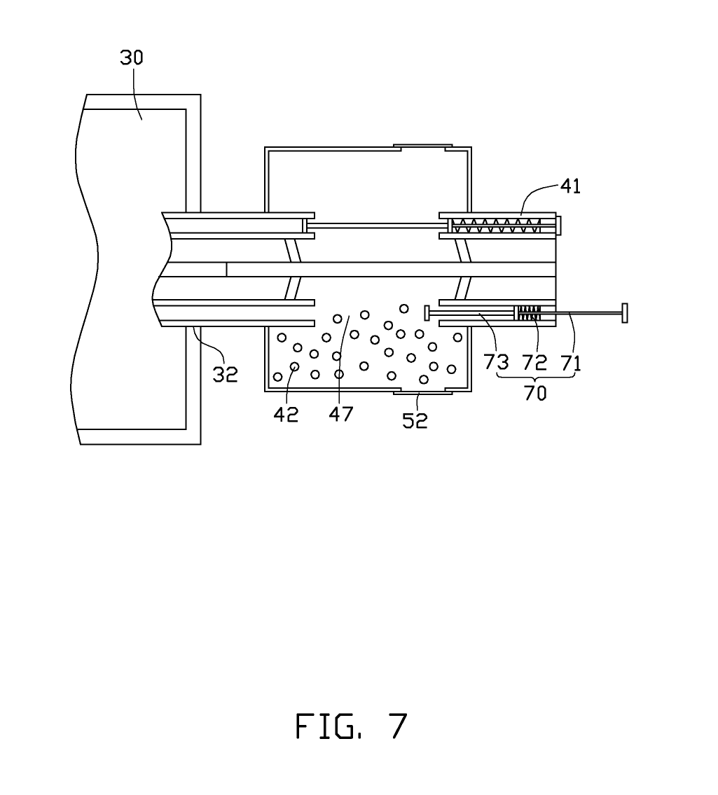

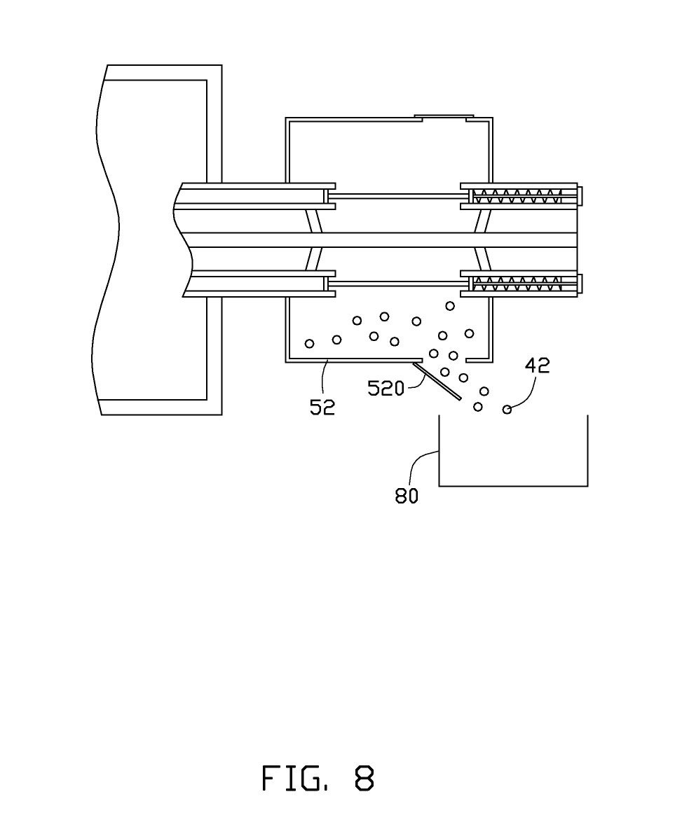

Referring to FIGS. 7-8, when the cable 33 needs to be replaced or removed, the handle 71 of the second switching assembly 70 is pulled out, and the metal plate 73 is pulled away from the outlet 47 against the elastic member 72. The metal oxide powders 42 in the inner tube 410 are unloaded from the inner tube 410 through the outlet 47 and enter the second box 52. The metal plate 73 recovers the outlet 47 under the elastic force of the elastic member 72. By opening the second hinged door 520 of the second box 52, the metal oxide powders 42 drop into a powder container 80.

In the present disclosure, in a process of loading the metal oxide powders 42 and removing the metal oxide powders 42, the cooperation between the first switching assembly 60 and the first box 50 or the cooperation between the second switching assembly 70 and the second box 52 is able to prevent the escape of cold or cooling air from the container 30.

In addition, the EMI-inhibiting devices 20 and 40 prevents the ingress of insects into the containers 10 and 30 through the wire holes 12 and 32.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A cable electromagnetic interference (EMI) inhibiting device for inhibiting EMI transferred through a cable extending from a housing of an electronic device, the EMI-inhibiting device comprising:
a metal cylinder connected to the housing and fitting about the cable; and
a plurality of metal oxide powders packed between the metal cylinder and the cable.

2. The EMI-inhibiting device of claim 1, wherein the metal cylinder comprises two blocking tabs spaced in a lengthways direction of the metal cylinder, the cable extends through the blocking tabs, the metal oxide powders are accommodated between the blocking tabs.

3. The EMI-inhibiting device of claim 2, further comprising two metal covers, wherein the metal cylinder defines an inlet in a top of the metal cylinder and an outlet in a bottom of the metal cylinder, the inlet and the outlet are defined between the blocking tabs, the metal covers are rotatably connected to the metal cylinder, and respectively cover or uncover the inlet and the outlet.

4. The EMI-inhibiting device of claim 2, wherein the metal cylinder comprises an inner tube and an outer tube fitting about the inner tube, the inner tube is spaced from the outer tube, the inner tube comprises an end engaged with a circumferential edge bounding a wire hole defined in the housing through which the cable extends, the blocking tabs are arranged in the inner tube, the metal oxide powders are packed between the inner tube and the cable.

5. The EMI-inhibiting device of claim 4, wherein the metal cylinder defines an inlet in a top of the metal cylinder and an outlet in a bottom of the metal cylinder, the inlet and the outlet both communicate with the inner tube.

6. The EMI-inhibiting device of claim 5, further comprising two metal plates located between the inner tube and the outer tube, wherein the metal plates respectively cover or uncover the inlet and the outlet.

7. The EMI-inhibiting device of claim 6, further comprising two handles and two elastic members, wherein the handles and the elastic members are located between the inner tube and the outer tube, each of the handles comprises an end abutting against an end of the metal cylinder opposite to the housing, each handle is connected to a corresponding metal plate, each elastic member is compressed between the end of the metal cylinder and a connection portion between a corresponding one of the handles and the corresponding metal plate.

8. The EMI-inhibiting device of claim 6, further comprising a first box and a second box located at top and bottom portions of the outer tube of the metal cylinder, respectively, wherein the first and second boxes cover the inlet and the outlet of the metal cylinder, respectively, the first box forms a first door mounted to a top of the first box, the second box forms a second door mounted to a bottom of the second box, the first and second boxes are made of metal material.

9. The EMI-inhibiting device of claim 1, wherein the metal oxide powders are magnetic and conductive.

10. The EMI-inhibiting device of claim 11, wherein the metal oxide powders are Mn—Zn ferrite power or Ni—Zn ferrite power.

11. A container data center, comprising:
a container defining a wire hole;
a cable extending through the wire hole of the container; and
a cable electromagnetic interference (EMI) inhibiting device comprising a metal cylinder fitting about the cable and a plurality of metal oxide powders packed between the metal cylinder and the cable, the metal cylinder comprises an end inserted into the wire hole of the container and engaged with a circumferential edge bounding the wire hole.

12. The container data center of claim 11, wherein the metal cylinder comprises two blocking tabs spaced in a lengthways direction of the metal cylinder, the cable extends through the blocking tabs, the metal oxide powders are accommodated between the blocking tabs.

13. The container data center of claim 12, wherein the metal cylinder defines an inlet in a top and an outlet in a bottom, the inlet and the outlet are defined between the blocking tabs, the EMI-inhibiting device further comprises two metal covers, the metal covers respectively cover or uncover the inlet and the outlet.

14. The container data center of claim 12, wherein the metal cylinder comprises an inner tube and an outer tube fitting about the inner tube, the inner tube is spaced from the outer tube, the blocking tabs are arranged in the inner tube, the metal oxide powders are packed between the inner tube and the cable.

15. The container data center of claim 14, wherein the metal cylinder defines an inlet in a top and an outlet in a bottom, the inlet and the outlet both communicate with the inner tube.

16. The container data center of claim 15, wherein the EMI-inhibiting device further comprises two metal plates located between the inner tube and the outer tube, the metal plates respectively cover or uncover the inlet and the outlet.

17. The container data center of claim 16, wherein the EMI-inhibiting device further comprises two handles and two elastic members, the handles and the elastic members are located between the inner tube and the outer tube, each of the handles comprises an end abutting an end of the metal cylinder opposite to the container, each handle is connected to a corresponding metal plate, the elastic members are compressed between the end of the metal cylinder opposite to the container and the connection portions between the handles and the corresponding metal plates, respectively.

18. The container data center of claim 16, wherein the EMI-inhibiting device further comprises a first box and a second box located at top and bottom portions of the outer tube of the metal cylinder, respectively, the first and second boxes cover the inlet and the outlet of the metal cylinder, the first box comprises a first door detachably mounted to a top portion of the first box, the second box comprises a second door detachably mounted to a bottom portion of the second box, the first and second boxes bare made of metal material.

19. The container data center of claim 11, wherein the metal oxide powders are magnetic and conductive.

20. The container data center of claim 19, wherein the metal oxide powders are Mn—Zn ferrite power or Ni—Zn ferrite power.
